(19) United States
(12) Patent Application Publication
(10) Pub. No.: US 2024/0397873 A1
(43) Pub. Date: Dec. 5, 2024

(54) HARVESTING DEVICE COMPRISING A CONVEYING MEMBER HAVING CONTROLLED TINES

(71) Applicant: Carl Geringhoff GmbH & Co. KG, Ahlen (DE)

(72) Inventors: Christian Brox, Ascheberg (DE); Steffen Sudhues, Ahlen (DE); Michael Pokriefke, Hude (DE)

(21) Appl. No.: 18/665,229

(22) Filed: May 15, 2024

(30) Foreign Application Priority Data
May 31, 2023 (DE) DE102023114298.4

(51) Int. Cl. A01D 75/18; A01D 61/00

(52) U.S. Cl. CPC A01D 75/182; A01D 61/008

(57) ABSTRACT

A harvesting device includes a conveying member having controlled tines. In order to protect the controlled tines and the crankshaft on which the controlled tines are mounted from an overload. The overload protection is connected on its side facing the dead shaft to the dead shaft and on its side facing away from the dead shaft, via a retainer, to the frame; the overload protection operates as a spring element, which, under the action of an overload, through spring motion, allows a rotary motion of the dead shaft from an initial position into a deflected position by absorbing an overload acting on the dead shaft and, building up in itself restoring forces, and, after the disappearance of the overload, the spring element can move back automatically into its original position, driven by restoring forces in the spring element, and also resets the dead shaft to its initial position.

### CROSS REFERENCE TO RELATED APPLICATIONS

This application claims priority under 35 U.S.C. § 119 to German Patent Application DE 10 2023 114 298.4, filed May 31, 2023, which is herein incorporated by reference in its entirety, including without limitation, the specification, claims, and abstract, as well as any figures, tables, appendices, or drawings thereof.

### FIELD OF THE INVENTION

The present invention relates to a harvesting attachment that can yield more easily to foreign bodies in the crop mat.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

U.S. Pat. No. 7,392,646 B2 discloses the use, in a draper header as an example of a harvesting device, of a feed roller as a functional conveying member. The feed roller has an undershot conveying action, takes up the crop at the front from the central belt of the draper header, and conveys it rearward by means of its rotating motion in the direction of the oblique conveying duct of a combine harvester to which the draper header is attached.

In order to assist the conveying action, the conveying member is fitted with controlled tines. In the front part of the feed roller, which faces in the working direction, the tips of the tines project furthest from the cylindrical casing of the feed roller. When the feed roller rotates in its direction of rotation, the tips of the tines take the available crop along and compress it downward in the process and simultaneously convey it downward and rearward in the discharge direction. During this process, the tips of the tines are retracted increasingly into the cylindrical casing until they are completely retracted on the rear side of the cylindrical casing. During further rotation of the feed roller, the tips of the tines are extended again until they once again project to the furthest extent from the cylindrical casing of the feed roller. By virtue of the controlled motion of the tines, which extend forward during the rotation of the feed roller, they engage from above in a crop mat presented to the feed roller, compress it downward, rake it toward the feed gap between the underside of the feed roller and the bottom of the harvesting device during the rotary motion, push it through the feed gap and then withdraw fully from the crop mat in order to avoid wrapping crop around the conveying member. They thereby assist in the discharge and compacting of the crop mat in a region, which is critical for the conveying action.

The previously known feed roller with the section in which the controlled fingers are located is part of a feed auger, which extends over a large part of the working width of the draper header. However, the section in which the crop mat is discharged rearward in the direction of the inclined conveyor forms only a small part of the feed auger. This results in a conflict of aims with respect to the optimization of the functioning of the two components.

While the feed auger with its auger plates is passed as close and continuously as possible, at a constant height, across the bottom of the harvesting device in order also to convey away particularly the grains as far as possible continuously, effectively, and without breaking the grains, the crop is engaged at only certain points and moved in the conveying direction by means of the tines in the region in which the controlled tines enter the crop mat. Because the controlled tines act only at certain points, it is possible that foreign bodies in the crop flow may enter the region between one or more tines and the bottom of the harvesting device, as a result of which the tine or tines is/are then obstructed in their rotary motion and are bent or broken off entirely. The controlled fingers must, therefore, be able to yield to foreign bodies, which could damage the controlled fingers or their mounting on the crankshaft or even the crankshaft itself. In the previously known device, the feed roller is held on an arm, which is held in such a way that it can be pivoted about a bearing pin, but the arm itself is rigid, and its mobility is limited to a pivoting motion in the vertical direction. Owing to its mass, this structure cannot respond quickly enough to force peaks, which occur suddenly. Moreover, the mass of this structure means that the feed roller cannot adapt in a sufficiently quick and finely graduated manner to a fluctuating thickness of the crop mat being conveyed.

Thus, there exists a need in the art for a harvesting attachment, which can yield more easily to foreign bodies in the crop mat.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

An aspect of the present disclosure is a harvesting device that includes a frame and a conveying member, which can be driven in rotation about an axis of rotation and is mounted for rotary motion at opposite first and second ends and, at least in one section, has a cylindrical casing, in which the conveying member conveys the crop away with an undershot action in a direction tangential to the cylindrical casing during its rotary motion, wherein, in this section, the conveying member has controlled tines, which, at least in part of the cylindrical casing, project beyond the latter in an at least approximately radial direction with respect to the axis of rotation of the conveying member, the tines are mounted for rotary motion on a crankshaft, which is arranged in the interior of the conveying member, is rigidly connected to a dead shaft and, in the bearing region of each tine, has a radial offset with respect to the axis of rotation of the conveying member, the conveying member is held rotatably at its first end on a pivotably mounted link arm and is rigidly connected to a drive and is rotatably mounted at its second end, via a rotary bearing, on a dead shaft, which is held on a pivotably mounted link arm, wherein the tines are protected against an overload by an overload protection, wherein the overload protection is connected on its side facing the dead shaft to the dead shaft and on its side facing away from the dead shaft, via a retainer, to the frame, the overload protection is designed as a spring element, which, under the action of an overload, by means of a spring motion, allows a rotary motion of the dead shaft out of an initial position into a deflected position by absorbing an overload acting on the dead shaft and, in the process, building up in itself restoring forces, and, after the disappearance of the overload, the spring element is capable of moving back automatically into its original position, being driven by the restoring forces in the spring element, and, in the process, also resets the dead shaft to its initial position.

Attention is expressly drawn to the fact that the invention, described immediately, in the Paragraph above, can be implemented in any desired combination with the features of individual dependent claims or of all of the dependent claims, unless there is some technically compelling reason to the contrary.

The overload protection is connected on its side facing the dead shaft to the dead shaft and on its side facing away from the dead shaft, via a retainer, to the frame. The overload protection is designed as a spring element, which, under the action of an overload, by means of a spring motion, allows a rotary motion of the dead shaft out of an initial position into a deflected position by absorbing an overload acting on the dead shaft and, in the process, building up in itself restoring forces. After the disappearance of the overload, the spring element is capable of moving back automatically into its original position, being driven by the restoring forces in the spring element, and, in the process, also resets the dead shaft to its initial position.

Arranged between the frame and the conveying member is a machine element in the form of a spring element, which has the desired flexibility and speed of response to avoid overloads on the tines. The spring motion is a response to force peaks which are introduced via the tines into the crankshaft and the dead shaft rigidly connected to the latter and which represent an overload in terms of the technical design of these machine components. The characteristic of the spring element is matched to the loads and force peaks, which are considered to be an overload in the design of the tines, the crankshaft, and/or the dead shaft. As a result, the spring element can always respond to defined overloads with a yielding motion. Since the spring element is arranged as a force accumulator between the dead shaft and the frame of the harvesting device, it also allows a rotary motion of the dead shaft about its own axis during its own yielding or resetting motion, by means of which rotary motion the tines, the crankshaft and the dead shaft yield to load peaks acting on these machine elements and can return to their initial position. When the dead shaft rotates about its own axis during a yielding motion, the angular position of the crankshaft rigidly connected to the dead shaft is also changed by the angular degrees corresponding to the rotary motion of the dead shaft. Owing to the changed relative position of the crankshaft, there is also a simultaneous change in the angular position of the tines supported on the crankshaft. Depending on the direction of rotation of the dead shaft, the angular position becomes steeper or shallower in relation to the conveying member during this process, and the tines also project to a greater or lesser extent beyond the circumferential surface of the cylindrical casing than would be the case if the dead shaft had not rotated on account of the overload.

A force peak refers to the action of a force, which is great enough to deform the spring element from its original shape. When the forces acting on the conveying member and/or the tines are so small that the spring element is not yet deformed in accordance with its spring characteristic, these machine elements are also not yet overloaded. The forces which are then acting on the spring element are not yet force peaks or an overload in the sense according to the invention. As regards its deformation behavior and its spring characteristic, the spring element is designed in such a way that it is not yet deformed, or is deformed to a virtually imperceptible extent, during such a normal operating mode. Accordingly, the tines, the crankshaft, and the dead shaft also do not change their spatial position or their rotary position in relation to the conveying member on account of a deformation of the spring element. As regards its deformation behavior and its spring characteristic, the spring element is designed in such a way that, in the case where the forces acting on one or more tines, the crankshaft and/or the dead shaft exceed a limit value which is regarded as critical for the undamaged state of these components, it begins to be deformed with an expansion motion. Accordingly, the design of the spring element is matched to the forces, which are regarded as critical for the absence of damage to the conveying member and the tines. In this sense, according to this invention, force peaks and an overload should be regarded as forces, which are above the limit values deemed to be critical.

With its spring travel, the spring element creates an adjustment travel, which enables force peaks to be dissipated quickly and easily over its length. The spring element can respond flexibly to force peaks without the mass of a conventional overload protection being accelerated or the breakaway torque of the mounting of a conventional overload protection having to be overcome during this process. In this way, the spring element forms an overload protection by means of which the respectively loaded tine or tines, the crankshaft and the dead shaft are protected from damage that might otherwise be a risk. Since the spring element is arranged directly between the frame and the dead shaft, response movements can take place directly at the dead shaft and not merely indirectly by way of movements of elements in a conventional overload protection. The spring element itself forms the overload protection, and, as a result, it is possible to dispense with additional components. It is thereby possible to reduce the outlay on components, the assembly effort, and the weight of machinery.

The term “dead shaft” refers to a shaft, which is not driven. However, the dead shaft can move independently of this, in particular with the spring element of the overload protection, if the conveying member rolls on a crop mat with a fluctuating thickness of material and there is a case of overload.

During a spring motion, the spring element also builds up restoring forces, by means of which the conveying member is automatically moved back into the initial position after the force peaks have disappeared. As a spring element, it is possible, in particular, to use a mechanical spring. Such a mechanical spring is economical, requires little maintenance, is durable, and can be replaced at a low cost.

The harvesting device may be a cutterbar for cutting grain, a mower, a corn header, a forage mower, or a pickup device, in which a correspondingly equipped conveying member with controlled tines and the above-described overload protection is installed. The spring element may be a suitable spring produced from strip steel or spring steel. Other flexible materials, such as rubber or fiber-reinforced plastic, may also be considered as a material for the spring element. The spring characteristic may be linear, degressive, or progressive.

Response movements that can be carried out by the spring element are not limited to response movements, which result from force peaks that act on a tine in a precisely axial direction; on the contrary, the shape of the spring element can also adapt elastically to forces which act on a tine in an only approximately axial or a more lateral direction. In particular, these may also be forces, which act on the spring element on account of the thickness of the crop mat conveyed by the conveying member, which varies continuously during the harvesting work. As a result, the tines have a high flexibility in their conveying behavior, allowing them to adapt easily and flexibly to changing working conditions.

According to one embodiment of the invention, the spring element is configured as a helical spring, the helical wire windings of which are placed around the dead shaft, and the first end of which is connected to the dead shaft and the second end of which is connected to the retainer. While force peaks acting on the tines from a direction transverse to the direction of rotation of the conveying member can be absorbed more suitably by plastic guides inserted into the cylindrical casing in the region in which the tines pass outward through the outer wall of the cylindrical casing of the conveying member, it is only with much greater difficulty that force peaks acting on the crankshaft from an axial direction of the tines can be absorbed and compensated for by conventional overload protections.

While the plastic guides inserted from the outside into the cylindrical casing can simply break off in order to yield to the laterally acting force and thereby dissipate the force peak that is acting, such a solution is unsuitable, particularly for the connection of a tine to the crankshaft at which an overload acting in the axial direction is transmitted to the crankshaft. Plastic elements that simply break off within the conveying member are difficult to access and can only be replaced with a considerable repair effort. Moreover, after the plastic element had broken off, the tines would no longer be connected to the crankshaft and would enter the machine downstream of the harvesting device, e.g., a combine harvester, together with the crop, where they could cause considerable additional damage, or they would fall directly onto the ground and thus be lost, which is likewise undesirable for several reasons.

If a tine is acted upon by a force peak, in particular a force peak acting in the axial direction of the tine, e.g., because the point of the tine strikes a stone, which is not deflected, the force vector acting on the crankshaft on account of the contact with the foreign body is perpendicular to the longitudinal axis of the crankshaft in very rare cases and, even then, only for a very short time. That also applies especially because the angular position of the tines on the crankshaft varies continuously during the harvesting work owing to the continuous rotation of the conveying member about its axis of rotation. Usually, the longitudinal axis of a tine is directed past the axis of rotation of the crankshaft during a rotation of the conveying member. If a force peak then acts in the axial direction of the tine, this force peak generates a moment of force directed past the axis of rotation of the crankshaft, which is then absorbed by the spring element and converted into an expansion motion of the spring element. Since the spring element is designed as a helical spring which is placed around the outside of the dead shaft, to which the crankshaft is connected for conjoint rotation, a force peak acting on a tine in the axial direction and directed past the axis of rotation of the crankshaft is introduced into a force absorption element in the form of the helical spring which is movable with an expansion motion in the force direction of the overload which is acting. By virtue of the arrangement in which the winding of the helical spring runs around the dead shaft, said spring is capable of expanding in the direction of the force that is acting upon it. As a result, the force transmission of the force peak from the tine to the helical spring takes place in an identical direction of action, thereby making it possible to keep the structure simple and light without impairing the overload protection effect as a result. If the helical spring has a plurality of turns, the acting moment of force can be distributed between a plurality of turns.

The expansion motion of the helical spring results in an actuating travel by which the dead shaft and, thus also, the crankshaft rigidly connected to the latter can rotate in its angular position relative to the angular position of the conveying member as long as the helical spring is expanded. Since the acting overload is deflected into an expansion motion of the helical spring, the force peak acting on the tines is neutralized in the tines, the crankshaft, and the dead shaft. These machine members are thereby protected from damage. The controlled motion of the tine can also change by the amount of the actuating travel, as a result of which the tine is relieved of the overload acting on it. If the overload disappears, the helical spring can contract to its original shape again. During this process, the actuating travel made available to the dead shaft, the crankshaft, and the tine during the expansion motion of the helical spring is reversed, and therefore, the dead shaft, the crankshaft, and the tine are once again in the angular positions and control positions in which they are also supposed to be located in a state not subject to an overload after the rotary actuation of the conveying member.

According to one embodiment of the invention, the spring element is formed from a wire. A round wire made of iron with a diameter of, for example, 5-15 mm can be used as a wire, for example. The metallic material has an intrinsic elasticity inherent in the material which allows a multiple expansion motion of the spring element with a subsequent reverse contraction into the initial shape. Even if, by virtue of the design in the form of a wire, the spring element now has an intrinsic elasticity, the spring element can respond to a force peak acting on a tine by a yielding movement corresponding to the direction of the force vector acting on the overload protection as a result of the force peak.

According to one embodiment of the invention, the retainer and the spring element are formed integrally from a wire. If the overload protection and the spring element are formed integrally from the same wire, the installation of the overload protection and the retainer are simplified because the two of them now no longer have to be connected to one another as separate components.

According to one embodiment of the invention, the pivoting travel of the retainer and/or of the spring element is limited by at least one stop. If the spatial position of the dead shaft can change more easily on account of the novel overload protection, it is advantageous to limit the range of motion of the overload protection by means of stops, e.g., at the top and/or bottom, in order to prevent the tines or other parts of the conveying member from colliding with other components of the harvesting device or moving too far upward away from the bottom of the harvesting device, with the result that the tines and the conveying member can no longer convey the crop away effectively.

According to one embodiment of the invention, a plurality of articulation points is formed on the harvesting device, in which articulation points are situated in a different spatial position with respect to the dead shaft, at which the overload protection can be connected to the frame of the harvesting device via the retainer. Changing the attachment of the overload protection from one articulation point to another articulation point results in changed timings for the controlled tines on account of the resulting change in the spatial position of the dead shaft and the resulting adjustment of the crankshaft in relation to the rest of the conveying member. The articulation points can differ from one another, both in depth and in height. It is advantageous if the various articulation points are arranged in one vertical plane because this makes adjustment easier and makes the choice of a suitable articulation point clearer. The different articulation points can be formed in a slotted link plate.

According to one embodiment of the invention, the retainer designed as a wire is cranked by 90° at its frame end, the articulation points are designed as plug-in holes in a slotted link plate, the retainer is held on an adjusting lever, by means of which the retainer is held in a fixed position in a plug-in hole, and the adjusting lever is designed to lift the cranked frame end of the retainer out of a plug-in hole and to lower it into such a hole. A retainer designed as a wire is held and guided well in an articulation point designed as a plug-in hole. By means of the adjusting lever, the cranked end of the retainer can be held in a selected plug-in hole. The adjusting lever makes it easier to transfer the retainer from one articulation point to another articulation point.

According to one embodiment of the invention, the harvesting device is designed as a grain table with at least three frame parts, which are distributed over the working width and are connected to one another in an articulated manner; the crop harvested by the cutterbar for cutting grain is gathered centrally and discharged via a discharge opening situated in the central frame part to a harvesting machine arranged downstream in the crop flow, wherein the conveying member is situated in the central frame part. When the above-described conveying member is installed in a cutterbar for cutting grain with the likewise above-described overload protection, particularly effective use of the technology proposed is obtained.

According to one embodiment of the invention, the conveying member has, in its sections projecting beyond the cylindrical casing, a conical shape or a frustoconical shape on which an auger plate is mounted. Since the conveying member conveys the crop away in a particularly effective manner with an undershot action in the section in which the controlled tines are located, but, depending on the application, crop material may also be fed to the conveying member from the side, particularly ready acceptance of the laterally fed crop is obtained in the region of transition from the lateral feeding of the crop to the section in which the controlled tines are located by virtue of the conical or frustoconical shape, because this leaves a large amount of space in the upper, narrow region of the conical shape for the crop fed in, but the auger plate then engages the crop arriving there and conveys it into the section in which the controlled tines are located. By means of the auger plates, the crop, which is fed to the conveying member over a width at the front that is greater than that of the section that has the controlled tines, is also pushed from the side into the region of action of the controlled tines.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

The invention is described below on the basis of the figures. The figures are only exemplary and do not restrict the general concept of the invention. In the figures:

FIG. 1 shows a view obliquely from the front and above of a cutterbar for cutting grain;

FIG. 2: shows an enlarged detail of the conveying member shown in FIG. 1;

FIG. 3 shows a view of the conveying member with exposed ends; and

FIG. 4 shows a perspective-sectioned view through a conveying member.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

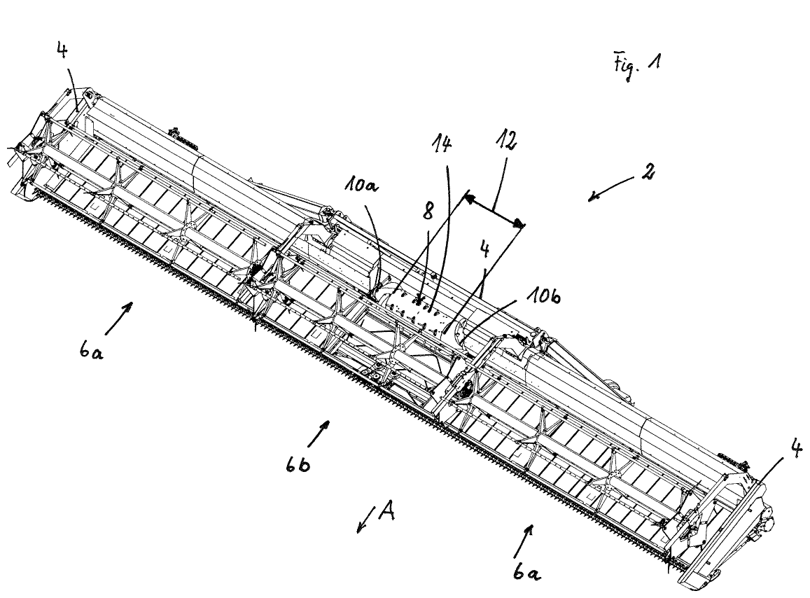

Referring now to the figures, FIG. 1 shows a view obliquely from the front and above of a cutterbar for cutting grain as one exemplary embodiment of a harvesting device 2. The harvesting device 2 has a frame 4, on which the components of the harvesting device 2 are secured. In the exemplary embodiment, the harvesting device 2 is embodied in three parts, wherein the lateral frame parts 6a are connected pivotably to the central frame part 6b. During harvesting, the harvesting device 2 is moved across a field in the working direction A. The cut crop is conveyed transversely to the working direction A by the lateral frame parts 6a to the central frame part 6b and is there conveyed away in the direction of the conveying member 8 together with the crop cut in frame part 6b.

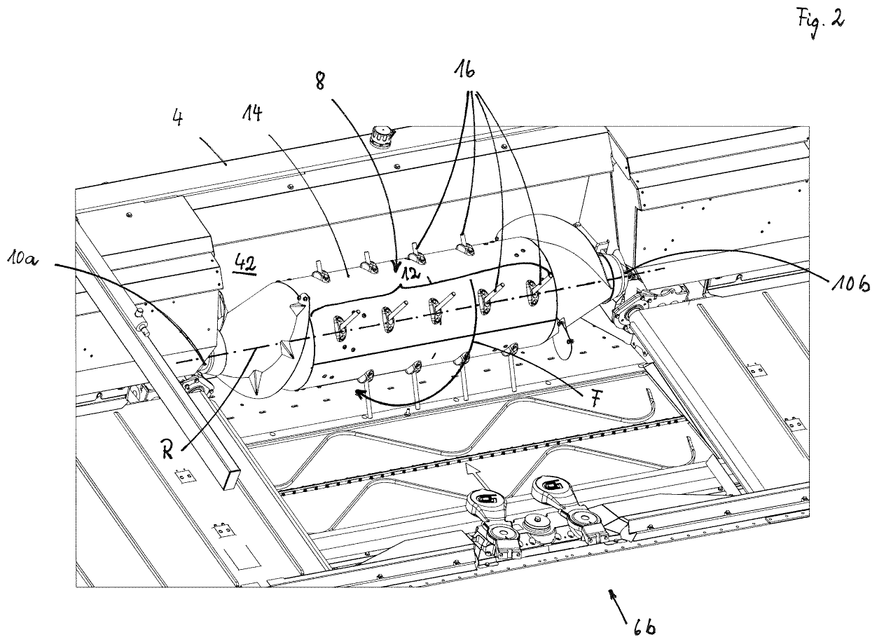

The conveying member 8 has a first end 10b and a second end 10a. Between these two ends 10a, 10b there is a section 12 with a cylindrical casing 14. In section 12, the conveying member 8 conveys the crop away in an undershot manner in a direction tangential with respect to the cylindrical casing 14 during its rotary motion, as indicated by the arrow in FIG. 2, which indicates the conveying direction F. The crop conveyed away by the conveying member 8 is discharged to a downstream machine through the discharge opening 42. FIG. 2 shows an enlarged detail of the conveying member 8 shown in FIG. 1. In section 12, the conveying member 8 has a number of controlled tines 16, which project beyond the cylindrical casing 14 in an at least approximately radial direction with respect to the axis of rotation R of the conveying member 8, at least in part of said cylindrical casing. In FIG. 2, the axis of rotation R is indicated by a dash-dotted line. In the view shown, it can be seen that the tines 16 project by different amounts beyond the cylindrical casing 14, depending on the angle of rotation of a particular tine 16. In general, it may be stated that the tines 16 project further at the front in the reception region than in the rear region, in which the tines 16 may also disappear completely into the cylindrical casing 14.

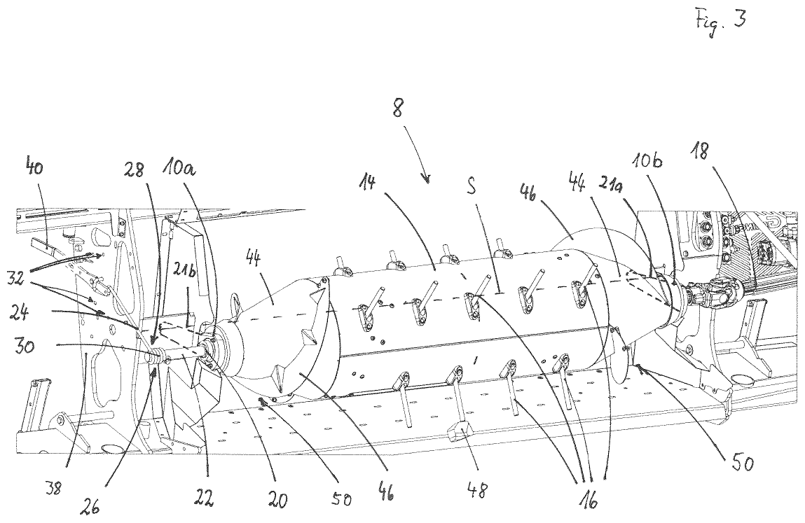

A rotary motion is imparted to the conveying member 8 at its first end 10b by means of a drive 18. For this purpose, the conveying member 8 is connected for conjoint rotation to the drive 18, in the exemplary embodiment shown as a drive shaft. At its second end 10a, the conveying member 8 is supported on the dead shaft 22 via a rotary bearing 20. The dead shaft 22 is illustrated in FIG. 3, which shows a view of the conveying member 8 with exposed ends. Dashed lines are used to illustrate the two link arms 21a, 21b, at which the conveying member 8 is held so as to be pivotable about a pivoting axis S, likewise indicated by a dashed line. The pivotable mounting by means of the link arms 21a, 21b enables the conveying member 8 to float on the crop mat, which is being conveyed through below the conveying member 8 in the direction of the discharge opening 42. The dead shaft 22 also moves upward or downward with the conveying member 8, depending on the direction of motion of the link arms 21a, 21b.

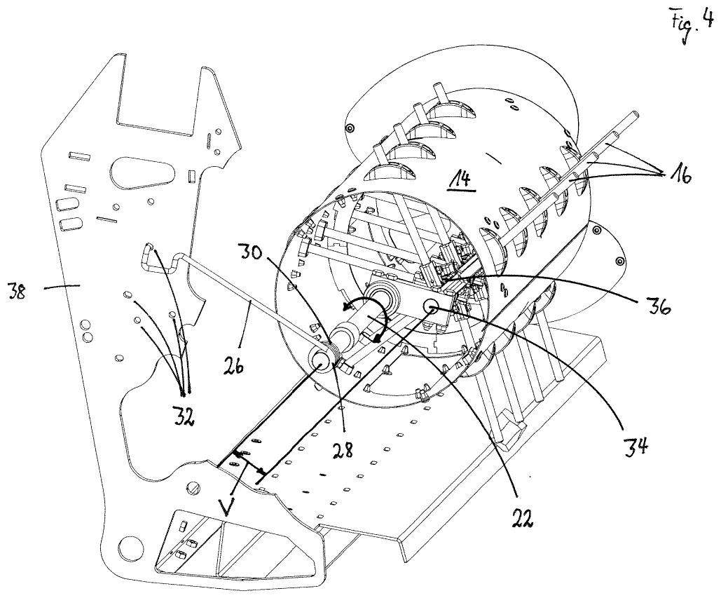

The dead shaft 22 is connected to the frame 4 of the harvesting device 2 via the spring element 28 of the overload protection 26 and the retainer 24. In the exemplary embodiment shown, the spring element 28 is a helical spring 30. During an expansion motion and a return motion of the spring element 28, the dead shaft 22 can rotate about its own axis in a corresponding direction indicated by the double arrow indicated in FIG. 4.

The overload protection 26 is connected to the frame 4 of the harvesting device 2 via the retainer 24 and an articulation point 32. In the views in FIGS. 3 and 4, it is possible to see a plurality of articulation points 32, which are arranged in a slotted link plate 38. The articulation points 32 are located in a different spatial position relative to the dead shaft 22. Depending on which of the articulation points 32 the 90°-cranked frame end of the retainer 24 is inserted, different timings for the controlled tines 16 are obtained on account of the resulting change in the spatial position of the dead shaft 22 and the resulting adjustment of the crankshaft 34 in relation to the rest of the conveying member 8. By means of an adjusting lever 40, the retainer 24 can be held in one of the various articulation points 32. However, the adjusting lever 40 can also be used as an adjusting aid in order to reposition the retainer 24 from one articulation point 32 to another articulation point 32.

In FIG. 4, the crankshaft 34 can be seen in the perspective sectioned view through the conveying member 8. The axis of the crankshaft 34 has an offset V in relation to the axis of rotation R and the dead shaft 22. Located on the crankshaft 34 are the bearing regions 36, in which the respective tines 16 are mounted and supported on the crankshaft 34. The crankshaft 34 is rigidly connected to the dead shaft 22 and is not driven in rotation.

When a force peak acts with an overload on a tine 16, in particular in an axial direction, owing to a foreign body 48, as shown in FIG. 3, the tine 16 generates a shock pulse in a direction transverse to the crankshaft 34 and to the dead shaft 22. This shock pulse, which, via the crankshaft 34 and the dead shaft 22, also acts on the retainer 24, can be absorbed by the spring element 28 and, in particular, the helical spring 30, by means of a spring motion, in particular an expansion motion. In this case, a restoring force is built up in the spring element 28. After the disappearance of the force peak, the spring element 28 automatically moves back into its original position, being driven by the restoring forces in the spring element 28.

In FIG. 3, it is also possible to see the sections 44 on the conveying member 8, which have a conical shape. One or more auger plates 46 are mounted on the envelope of the cone in the sections 44. In this way, the sections 44 form pockets 50, which are wedge-shaped toward the bottom of the harvesting device 2 and which very effectively absorb the crop conveyed in. By means of the auger plates 46, the crop accepted by the pockets 50 is guided into the region of action of the controlled tines 16.

The invention is not restricted to the exemplary embodiment described above. It is not difficult for those skilled in the art, using their specialist knowledge, to modify the exemplary embodiment in a manner that seems appropriate in order to adapt it to a specific application. From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Harvesting device |
| 4 | Frame |
| 6a | Lateral frame parts |
| 6b | Central frame part |
| 8 | Conveying member |
| 10a | First end |
| 10b | Second end |
| 12 | Section |
| 14 | Cylindrical casing |
| 16 | Tines |
| 18 | Drive |
| 20 | Rotary bearing |
| 21a | First link arm |
| 21b | Second link arm |
| 22 | Dead shaft |
| 24 | Retainer |
| 26 | Overload protection |
| 28 | Spring element |
| 30 | Helical spring |
| 32 | Articulation point |
| 34 | Crankshaft |
| 36 | Bearing region |
| 38 | Slotted link plate |
| 40 | Adjusting lever |
| 42 | Discharge opening |
| 44 | Sections |
| 46 | Auger plate |
| 48 | Foreign body |
| 50 | Pocket |
| A | Working direction |
| F | Conveying direction |
| R | Axis of rotation |
| S | Pivoting axis |
| V | Offset |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A harvesting device (2) comprising of a:
frame (4) and a conveying member (8), which can be driven in rotation about an axis of rotation (R) and is mounted for rotary motion at opposite first and second ends (10a, 10b); and
at least in one section (12), has a cylindrical casing (14), in which the conveying member (8) conveys the crop away with an undershot action in a direction tangential to the cylindrical casing (14) during its rotary motion, wherein, in this section (12), the conveying member (8) has controlled tines (16), which, at least in part of the cylindrical casing (14), project beyond the latter in an at least approximately radial direction with respect to the axis of rotation (R) of the conveying member (8), the controlled tines (16) are mounted for rotary motion on a crankshaft (34), which is arranged in the interior of the conveying member (8), is rigidly connected to a dead shaft (22) and, in the bearing region (36) of each tine (16), has a radial offset (V) with respect to the axis of rotation (R) of the conveying member (8), the conveying member (8) is held rotatably at its first end (10b) on a pivotably mounted link arm (21a) and is rigidly connected to a drive (18) and is rotatably mounted at its second end (10a), via a rotary bearing (20), on a dead shaft (22), which is held on a pivotably mounted link arm (21b), wherein the tines (16) are protected against an overload by an overload protection (26), wherein the overload protection (26) is connected on its side facing the dead shaft (22) to the dead shaft (22) and on its side facing away from the dead shaft (22), via a retainer (24), to the frame (4), the overload protection (26) is designed as a spring element (28), which, under the action of an overload, by means of a spring motion, allows a rotary motion of the dead shaft (22) out of an initial position into a deflected position by absorbing an overload acting on the dead shaft (22) and, in the process, building up in itself restoring forces, and, after the disappearance of the overload, the spring element (28) is capable of moving back automatically into its original position, being driven by the restoring forces in the spring element (28), and, in the process, also resets the dead shaft (22) to its initial position.

2. The harvesting device (2) according to claim 1, wherein the spring element (28) is configured as a helical spring (30), the helical wire windings of which are placed around the dead shaft (22), and the first end of which is connected to the dead shaft (22) and the second end of which is connected to the retainer (24).

3. The harvesting device (2) according to claim 1, wherein the spring element (28) is formed from a wire.

4. The harvesting device (2) according to claim 3, wherein the retainer (24) and the spring element (28) are formed integrally from a wire.

5. The harvesting device (2) according to claim 1, wherein the pivoting travel of the retainer (24) and/or of the spring element (28) is limited by at least one stop.

6. The harvesting device (2) according to claim 1, wherein a plurality of articulation points (32) is formed on the harvesting device (2), which articulation points (32) are situated in a different spatial position with respect to the dead shaft (22), at which the overload protection (26) can be connected to the frame (4) of the harvesting device (2) via the retainer (24).

7. The harvesting device (2) according to claim 1, wherein the retainer (24) is cranked by 90° at its frame end, the articulation points (32) are designed as plug-in holes in a slotted link plate (38), the retainer (24) is held on an adjusting lever (40), by means of which the retainer (24) is held in a fixed position in a plug-in hole, and the adjusting lever (40) is designed to lift the cranked frame end of the retainer (24) out of a plug-in hole and to lower it into such a hole.

8. The harvesting device (2) according to claim 1, wherein the harvesting device (2) is designed as a cutterbar for cutting grain with at least three frame parts (6a, 6b), which are distributed over the working width and are connected to one another in an articulated manner, the crop harvested by the cutterbar for cutting grain is gathered centrally and discharged via a discharge opening (42) situated in the central frame part (6b) to a harvesting machine arranged downstream in the crop flow, wherein the conveying member (8) is situated in the central frame part (6b).

9. The harvesting device (2) according to claim 8, wherein the conveying member (8) has, in its sections (44) projecting beyond the cylindrical casing (14), a conical shape or a frustoconical shape on which an anger plate (46) is mounted.
